(19) United States
(12) Patent Application Publication
(10) Pub. No.: US 2014/0226679 A1
(43) Pub. Date: Aug. 14, 2014

(54) METHOD FOR BUNDLING CROSS-BOARD MULTILINK PROTOCOL

(71) Applicant: Haidong Wang, Beijing (CN)

(72) Inventor: Haidong Wang, Beijing (CN)

(73) Assignee: Hangzhou H3C Technologies Co., Ltd., Hangzhou (CN)

(21) Appl. No.: 14/240,184

(22) PCT Filed: Aug. 31, 2012
(86) PCT No.: PCT/CN2012/080848

§ 371 Date: Feb. 21, 2014

(30) Foreign Application Priority Data
Oct. 28, 2011 (CN) 201110334959.5

(51) Int. Cl. H04L 12/933; H04L 29/06; H04L 12/935

(52) U.S. Cl. CPC H04L 49/15; H04L 49/30; H04L 69/18
USPC 370/419

(57) ABSTRACT

Bundling a cross-board Point-to-Point (PPP) Multilink Protocol (MP), according to an example, includes: negotiating with a first device, by a second device, to determine a maximum number of sessions supported by an MP link, when the MP link is established between the first device and the second device, allocating, by the second device, sessions to interfaces board of the second device such that the sessions are distributed among a plurality of interface boards of the second device; when receiving an MP fragment packet from the first device, the second device determines an interface board to which a session is allocated according to a session identification (ID) of the MP fragment packet, and sends the MP fragment packet to that interface board.

### BACKGROUND

Multilink bundling is a common mechanism for increasing bandwidth in actual networking. However, this mechanism may increase bandwidth redundancy. In a distributed device, cross-board link bundling may not only enable board-level redundancy, but may also allocate traffic load to multiple interface boards.

### BRIEF DESCRIPTIONS OF THE DRAWINGS

Features of the present disclosure are illustrated by way of example and not limited in the following figure(s), in which like numerals indicate like elements, in which:

FIG. 1 is a flowchart of a method for bundling cross-board Point-to-Point (PPP) Multilink Protocol (MP), according to an example of the present disclosure.

FIG. 2 is a diagram of cross-board MP bundling, according to an example of the present disclosure.

FIG. 3 is a structure diagram of a device, according to an example of the present disclosure.

Throughout the drawings, identical reference numbers designate similar, but not necessarily identical, elements.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

Detailed descriptions about the present disclosure are further provided in the following discussion, attached figures, and specific examples.

The present disclosure relates to multilink bundling technologies, and more particularly, to a method and device for bundling cross-board MP.

The present disclosure provides cross-board MP technologies based on a main MP channel. In a device having a plurality of interface boards, when an MP link is established, an interface board having a certain member port is selected as an MP fragment assembly board. This member port is referred to as a main MP channel. All of the packets received by the device may be transparently transmitted to the MP fragment assembly board for processing. An interface board having a non-main MP channel needs to transparently transmit received MP fragment packets to another interface board on which the main MP channel is located, for processing. Thus, when the main MP channel is physically down, it is necessary to re-select a main MP channel. The traffic may be cut off, and traffic transmission reliability may be reduced. In addition, the traffic may only be concentrated and processed in an interface board located by the main MP channel. Other interface boards may not be able to process traffic. Moreover, the transmission performance may be lower.

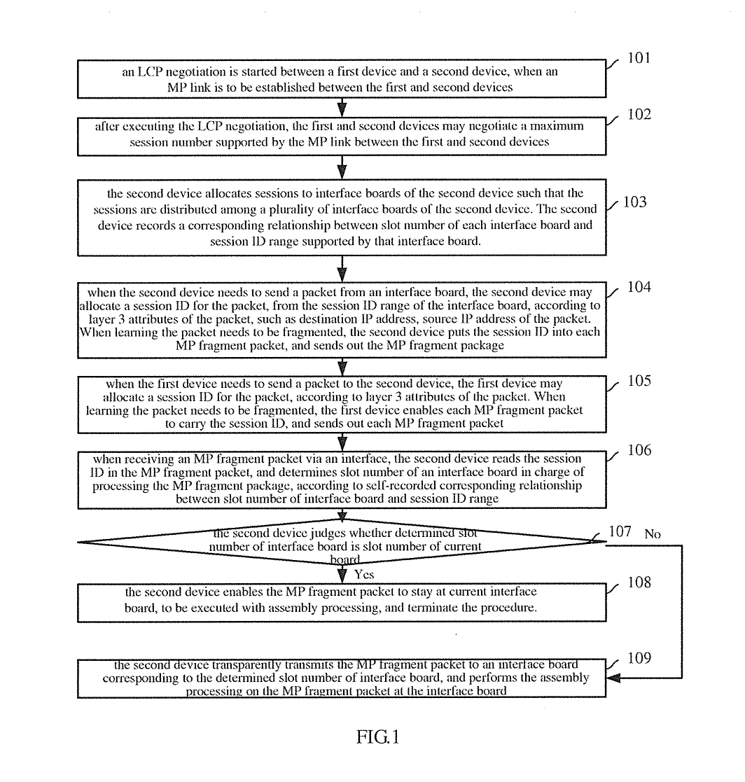

FIG. 1 is a flowchart of a method for bundling cross-board MP, according to an example of the present disclosure. As shown in FIG. 1, specific blocks are as follows.

Block 101: a first device establishes an MP link with a second device, and starts a Link Control Protocol (LCP) negotiation with the second device.

Block 102: after executing the LCP negotiation, a maximum number of sessions supported by the MP link established between the first and second devices may be determined.

Here, an LCP option is added, which is used for carrying the maximum number of sessions supported by the MP link established between the first and second devices. The format of the LCP option may be as follows.

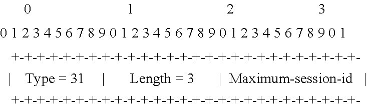

The Type denotes the type of the LCP option, the value thereof may be different from the Type value of an existing LCP option. For example, Type=31. Length denotes the length of the LCP option. Here, Length=3 bytes. Maximum-session-id denotes the maximum number of sessions supported by the MP link established between the two devices.

Block 103: The second device allocates the sessions to interface boards of the second device such that the sessions are distributed among a plurality of interface boards of the second device. The second device records a corresponding relationship between the slot number of each interface board and the session ID range supported by that interface board.

Block 104: When a packet is to be sent from an interface board, the second device may select a session ID from the session ID range of the interface board and may allocate the selected session ID for the packet according to layer 3 attributes of the packet, such as destination IP address, source IP address of the packet, etc. When a determination is made that the packet is to be fragmented, the second device may put the selected session ID into each MP fragment packet, and may send out each MP fragment packet.

With reference to an interface board, the session ID of an MP fragment packet sent out from the interface board is one session ID within the session ID range corresponding to the interface board.

Packets may be allocated to different sessions according to the destination IP address, source IP address of the packet, etc. Each session possesses a session ID.

Block 105: When performing MP fragment on packets in a same session, to ensure that the sequence of MP fragments is maintained, all of the packets in the same session may be fragmented by the same interface board.

When the first device is to send a packet to the second device, the first device may allocate a session ID for the packet, according to layer 3 attributes of the packet. When a determination is made that the packet is to be fragmented, each MP fragment packet may be enabled to carry the session ID and then may be sent out.

In one example of the present disclosure, a reserved bit in the MP header may be utilized to carry the session ID. The format of an MP fragment packet may be as follows.

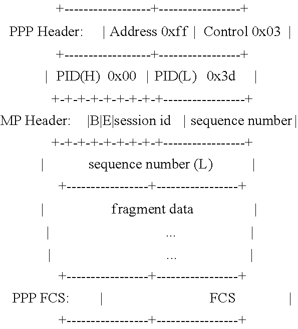

In the above, PPP Header is the header of Point-to-Point (PPP) link. MP Header is the header of the MP. B is a fragment start symbol. E is a fragment end symbol. Sequence number is a fragment order number. Sequence number (L) is the length of the fragment order number. Fragment data is segmented data. PPP Frame Check Sequence (FCS) is a check sequence of the PPP frame. Session ID is a field newly added in the example of the present disclosure, which is located in reserved bits after field E in the MP header. There may be 6 bits in the reserved bits. All of the 6 bits of the reserved bits may be taken as the Session ID field.

Block 106: The second device receives an MP fragment packet from an interface, reads the session ID in the fragment packet, and determines the slot number of an interface board in charge of processing the MP fragment packet, according to the self-recorded corresponding relationship between the slot number of the interface board and the session ID range.

Block 107: The second device determines whether the determined slot number of the interface board is the same as the slot number of the interface board which received the MP fragment packet. If yes, proceed with block 108; otherwise, proceed with block 109.

Block 108: The second device enables the MP fragment packet to stay at the current interface board to be executed with assembly processing and to terminate the process.

Block 109: The second device transparently transmits the MP fragment packet to another interface board which has a slot number corresponding to the slot number determined in block 106. The another interface board having the slot number determined in block 106 may then assemble the MP fragment data according to the Multilink Protocol.

The above processes may be carried out by hardware including electronic circuitry or logic for implementing the above processes (e.g. Application Specific Integrated Circuit (ASIC), Field Programmable Gate Array (FPGA), Complex Programmable Logic Device (CPLD) etc), or by software or firmware running on appropriate hardware, e.g. as machine readable instructions stored on a non-transitory machine readable medium and executed by one or more processors, or a combination thereof. For example, some of the blocks may be implemented by hardware, while others may be implemented by software running on a processor.

The following actions in particular may be implemented utilizing hardware, such as a Field Programmable Gate Array (FPGA), ASIC or CPLD, so as to accelerate transparent transmission processing of MP fragments. Read session ID in a fragment packet, and determine slot number of an interface board in charge of processing the MP fragment packet, according to a self-recorded corresponding relationship between the slot number of interface board and the session ID, in block 106. Determine whether the determined slot number of the interface board is the slot number of the current board in block 107. When the determined slot number of the interface board is not the slot number of the current board, transparently transmit the MP fragment packet to the interface board corresponding to the determined slot number of the interface board in block 109.

It should be noted that, in an example of the present disclosure, when a determination is made that an interface board is added to or removed from the current device, the second device is to re-allocate the sessions among the interface boards of the current device once again.

For example, when an interface board is added, the second device may respectively extract a certain number of sessions from among the sessions allocated to each interface board, and allocate the extracted sessions to the newly added interface board. When an interface board is removed, the second device may evenly allocate the sessions of the removed interface board to other interface boards.

An application example is provided in the following.

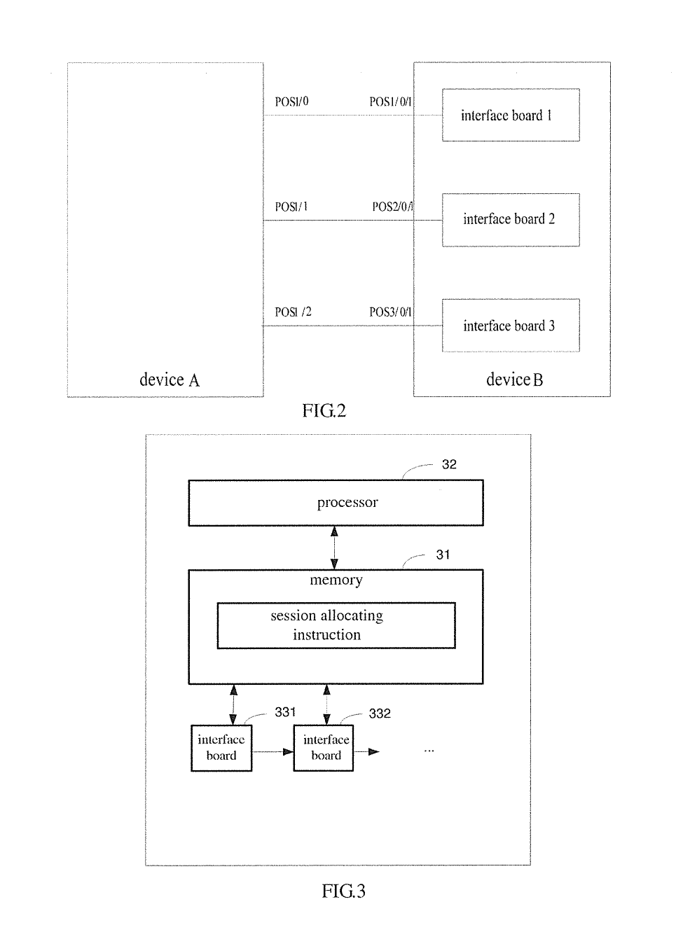

As shown in FIG. 2, an MP link is to be established between devices A and B. Regarding device A, the member port of the MP link is POS1/0, POS1/1, POS1/2. Regarding device B, the member port of the MP link is POS1/0/1, POS2/0/1, POS3/0/1, which respectively belong to interface boards 1, 2 and 3 of device B.

During the LCP negotiation stage, the maximum number of sessions negotiated by devices A and B is 64. The session ID is therefore from 0 to 63.

The device B may allocate the sessions as follows.

Interface board 1 is in charge of processing sessions with session ID from 0-21. Interface board 2 is in charge of processing sessions with session ID from 22-42. Interface board 3 is in charge of processing sessions with session ID from 43-63.

When device B is to send a packet, the specific processes may be as follows.

When the packet is processed with MP fragment at interface board 1, the session ID of the MP fragment packet will be 0-21.

When the packet is processed with MP fragment at interface board 2, the session ID of the MP fragment packet will be 22-42.

When the packet is processed with MP fragment at interface board 3, the session ID of the MP fragment packet will be 43-63.

When device B receives a packet, the specific processes may be as follows.

When a non-interface board 1 receives a packet, the session ID thereof is from 0-21, and the packet may be sent to interface board 1 to be processed.

When a non-interface board 2 receives a packet, and the session ID thereof is from 22-42, the packet may be sent to interface board 2 to be processed.

When a non-interface board 3 receives a packet, the session ID thereof is from 43-63, and the packet may be sent to interface board 3 to be processed.

FIG. 3 is a structure diagram of a device, in accordance with an example of the present disclosure. As shown in FIG. 3, the device mainly includes at least two interface boards 331,332, a memory 31, and a processor 32 in communication with the memory 31. The memory 31 stores a session allocating module comprising machine readable instructions executable by the processor 32.

The session allocating instruction indicates that the sessions are to be allocated among the interface boards of the current device, and that a corresponding relationship between the slot number of each interface board and the session ID range supported by each interface board is to be recorded in a memory of the current device. This allocation may occur when an MP link is established with a first device, and the maximum number of sessions supported by the MP link is negotiated with the first device during the LCP negotiation stage.

The session allocating instruction further indicates that all of the sessions are to be re-allocated among the interface boards of the current device, when a determination is made that an interface board is added to or removed from current board.

Each interface board of the at least two interface boards 331, 332 is to search in a corresponding relationship between the slot number of the interface board and the session ID range recorded according to the session allocating instruction, for a corresponding slot number of the interface board based on the session ID in a packet, when an MP fragment packet is received via the located interface sent by the first device, and to send the MP fragment packet to the interface board, which corresponds to the slot number of the interface board, to be executed with assembly processing.

Each interface board of the at least two interface boards 331, 332 is further to, after finding the corresponding slot number of the interface board, when a determination that the slot number of interface board is the slot number of the current interface board, perform assembly processing on the MP fragment packet at the current interface board; otherwise, send the MP fragment packet to an interface board, which corresponds to the slot number of interface board, to be executed with assembly processing.

Each interface board of the at least two interface boards 331, 332 is further to, when a packet is to be sent from the current interface board, allocate a session ID for the packet, according to the corresponding relationship between the slot number of the interface board and the recorded session ID range according to the session allocating instruction; when a determination is made that the packet is to be fragmented, enable each MP fragment packet to carry the session ID, and send out the each MP fragment packet. The interface board may put the session ID in reserved bits of the MP header in the MP fragment packet.

Thus in each example provided in the present disclosure, the sessions may be allocated among different interface boards, which may improve traffic transmission reliability and transmission efficiency.

In the example of FIG. 3 the session allocating instruction is implemented as machine readable instruction stored in memory and executable by a processor. However, it would also be possible for some or all of the functions of the session allocating module to be implemented by dedicated hardware including electronic circuitry or logic for implementing the above processes (e.g. ASIC, FPGA, CPLD). Further, the above described operations of the interface boards may be implemented as machine readable instructions stored on a non-transitory machine readable medium and executable by a processor, but some or all of the above described functions of the interface boards may conveniently be implemented by dedicated logic circuitry such as an ASIC, FPGA or CPLD etc.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for bundling a cross-board Point-to-Point (PPP) Multilink Protocol (MP) link between first and second devices, comprising:
the second device negotiating with the first device, to determine a maximum number of sessions supported by an MP link, and allocating the sessions to interface boards of the second device such that the sessions are distributed between a plurality of interface boards of the second device;
and in response to receiving an MP fragment packet from the first device, the second device determining an interface board to which a session is allocated according to a session identification (ID) of the MP fragment packet, and sending the MP fragment packet to said interface board to which the session is allocated.

2. The method according to claim 1, further comprising;
in response to finding that an interface board is added to or removed from the second device, the second device re-allocating the sessions among interface boards of the second device.

3. The method according to claim 1, further comprising;
after allocating, by the second device, sessions to the interface boards of the second device, when the second device is to send a packet from an interface board, allocating, by the second device, a session ID for the packet according to sessions allocated to the interface board; and
when a determination is made that the packet is to be fragmented, enabling, by the second device, each MP fragment packet to carry the session ID, and sending out each of the MP fragment packets.

4. The method according to claim 3, wherein the enabling, by the second device, the each MP fragment packet to carry the session ID comprises:
putting the session ID into reserved bits of an MP header in the MP fragment packet.

5. The method according to claim 1, wherein negotiating with the first device by the second device to determine the maximum number of sessions supported by the MP link comprises:
during a Link Control Protocol (LCP) negotiation stage between the first and second devices, determining the maximum number of sessions supported by the MP link.

6. A device comprising:
at least two interface boards;
and a session allocation module , to negotiate with another device, to determine a maximum number of sessions supported by an Point-to-Point (PPP) Multilink Protocol (MP) link with the another device, and to allocate all the sessions to each interface board of the device, when a MP link is established with the another device;
wherein each interface board is to determine an interface board to which a session is allocated according to a session identification (ID) in an MP fragment packet, when the MP fragment packet is received via the allocated interface board from the first device, and to send the MP fragment packet to the interface board to which the session is allocated for assembly processing.

7. The device according to claim 6, wherein the session allocating module is to re-allocate sessions among the interface boards of the device, in response to learning that an interface board has been added to or removed from the device.

8. The device according to claim 6, wherein the interface board is further to allocate a session ID for a packet according to sessions allocated to the current interface board when the packet is to be sent from the current interface board;
when a determination is made that the packet is to be fragmented, the interlace board is to enable each MP fragment packet to carry the session ID, and to send out each of the MP fragment packets.

9. The device according to claim 8, wherein the interface board is to put the session ID into reserved bits of an MP header of the MP fragment packet.

10. The device according to claim 6, wherein the session allocating module is to negotiate with the first device and to determine the maximum number of sessions supported by the MP link during a Link Control Protocol (LCP) negotiation stage.
